(19) United States
(12) Patent Application Publication
(10) Pub. No.: US 2009/0291424 A1
(43) Pub. Date: Nov. 26, 2009

(54) Computer television

(76) Inventor: Joseph Welcome, JR., Los Angeles, CA (US)

Correspondence Address: ITALIA IP, 3500 WEST OLIVE AVE., SUITE 300, BURBANK, CA, 91505, US

(21) Appl. No.: 11/804,499

(22) Filed: May 22, 2008

(51) Int. Cl. G09B 5/10

(52) U.S. Cl. 434/309

(57) ABSTRACT

A method for instructing a plurality of students, the method including: providing at least one central computer capable of simultaneously running a plurality of computer applications; providing at lease one central server in communication with the central computer; providing a plurality of student monitors and student input devices, each monitor and input device for use by a corresponding student and in communication with the central server; providing a instructor monitor and at least one instructor input device for use by an instructor, the instructor monitor and input device in communication with the central server; launching at least one application on the central computer; viewing the application on at least one of the master monitor and the plurality of student monitors; manipulating the application with at least one of said student monitors and student input devices; and monitoring at least one of the student monitors on the instructor monitor.

### CROSS-REFERENCE TO RELATED APPLICATION

This non-provisional patent application is a Continuation-in-Part of U.S. Non-Provisional patent application Ser. No. 11/804,499, entitled “Computer of the New Millennium,” filed May 15, 2007, which is hereby incorporated in its entirety.

### BACKGROUND

This application relates generally to a computer having the ability to display television programming. More specifically, this application relates to a computer having the ability to display television programming as well as provide assistance in educating students in the use of personal computers.

### SUMMARY

Computers have increasingly become integrated in the human experience. Computers have become useful for, among other things, education and entertainment. For example, computers are frequently used for viewing DVDs. However, the most common way of viewing live events or broadcast events involves streaming content from the Internet. Streaming content from the Internet, especially video content, is less than ideal as the streamed content is subject to poor resolution as well as multiple buffering episodes which leaves the content choppy and frustrating to watch. While live events and broadcast events are typically viewed on a traditional television set connected to a cable system, satellite system or antennae, traditional television sets are expensive. Thus, there is a significant need for a means to watch live or broadcast events using a computer whereby quality is maintained.

In an educational setting, each classroom is typically provided with multiple computer systems with one computer system constituting one student workstation. These workstations are typically interconnected by a network and provided Internet access by such a network. Unfortunately, these computer systems are expensive thus adding cost to the educational experience. In addition, due to the bulkiness of this typical set up, an instructor is not capable of easily monitoring or helping each student. Thus, there exists a significant need for an improved computer system capable of assisting in the efficient and economical education of students.

This application discloses systems and methods to meet the above-mentioned needs.

In particular, this application discloses a method for instructing a plurality of students, the method comprising the steps of: providing at least one central computer capable of simultaneously running a plurality of computer applications; providing at lease one central server in communication with said central computer; providing a plurality of student monitors and student input devices, each monitor and input device for use by a corresponding student and in communication with said central server; providing a instructor monitor and at least one instructor input device for use by an instructor, said instructor monitor and input device in communication with said central server; launching at least one application on said central computer; viewing the application on at least one of said master monitor and said plurality of student monitors; manipulating the application with at least one of said student monitors and student input devices; and monitoring at least one of said student monitors on said instructor monitor.

This application also discloses a computer system comprising: a computer; a multimedia input device; a network communication device; an integration box in communication with said multimedia input device, said network communication device and said computer, wherein said computer is capable of processing data transmitted from said multimedia input device and said network communication device.

Finally, this application also discloses an educational computer system comprising: at least one remote central computer unit capable of simultaneously running a plurality of computer applications; at least one remote central server in communication with said central computer unit; an instructor monitor and instructor input device in communication with said server; and a plurality of student monitors and student input devices, each of said student monitors and student input devices in communication with said server.

### BRIEF DESCRIPTION OF THE DRAWINGS

The drawings, when considered in connection with the following description, are presented for the purpose of facilitating an understanding of the subject matter sought to be protected.

FIG. 1 is a schematic view of a first embodiment of a computer system; and

FIG. 2 is a schematic view of a second embodiment of a computer system.

### DETAILED DESCRIPTION

While the present computer system is described with reference to several illustrative embodiments described herein, it should be clear that the present invention should not be limited to such embodiments. Therefore, the description of the embodiments provided herein is illustrative of the present invention and should not limit the scope of the invention as claimed.

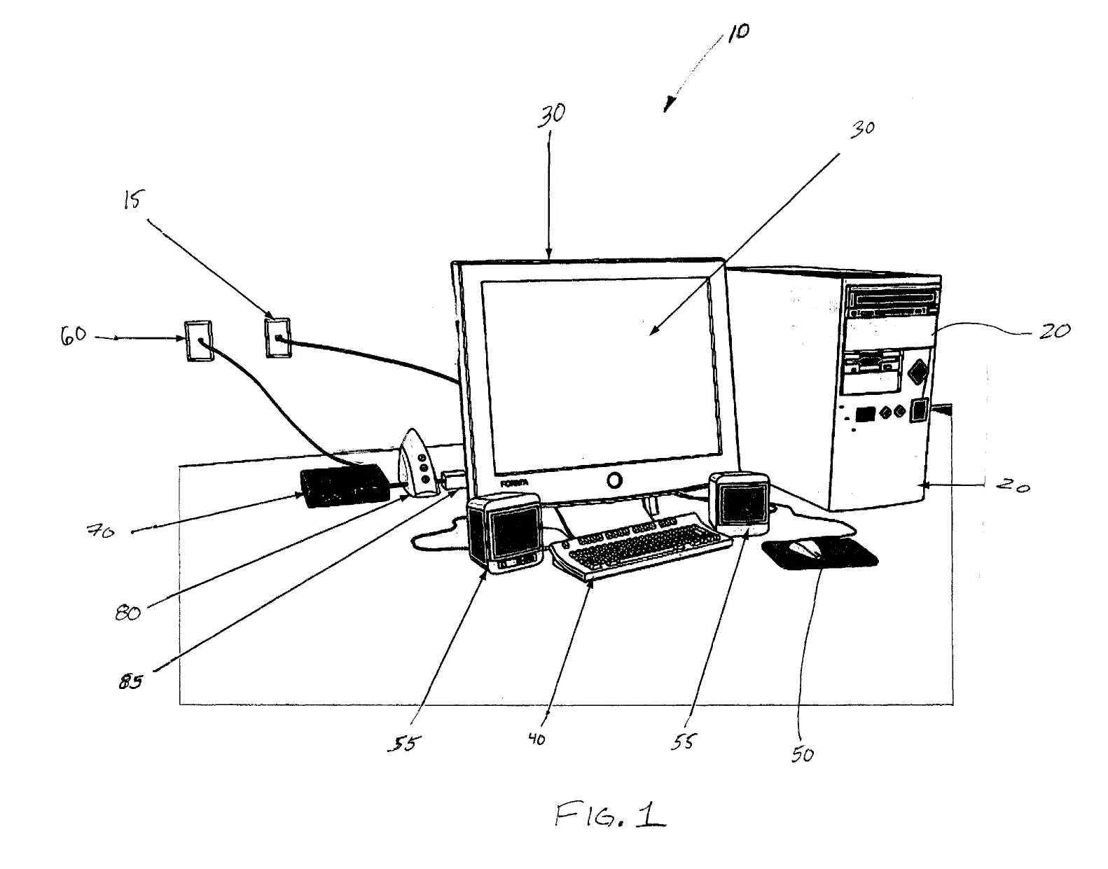

Referring now to FIG. 1, a first illustrative embodiment of a computer system 10 is shown. The system 10 generally includes a computer tower 20, a monitor 30, and one or more input devices, such as a keyboard 40 and/or a mouse 50. In the illustrative embodiment, the monitor 30 is 148 inches by 128 inches. The system 10 may also include one or more speakers 55. The system 10 is in communication with a network, such as the internet, by way of a network connection, such as by way of a telephone connection 60; other means for establishing a network connection will be apparent to those skilled in the art. In addition, the system 10 and its components are powered by electricity, such as via an AC outlet 15, as is known in the art.

The system 10 also includes a multimedia input device, such as a cable box 70, for receiving and transmitting a multimedia signal, such as a cable television signal. The multimedia device is not limited solely to a cable box 70 and other suitable devices will be appreciated by those skilled in the art, including but not limited to a satellite television box, a television antennae, etc.

The cable box 70 is in communication with a USB hub 80 which, in turn, is in communication with an integration box 85. The integration box 85 is in communication with the monitor 30, and thus permits the monitor to display the multimedia data from the communicated from the cable box 70. Advantageously, the system 10 permits the monitor 30 to display a television signal from the cable box 70 as well as data communicated from the computer tower 20.

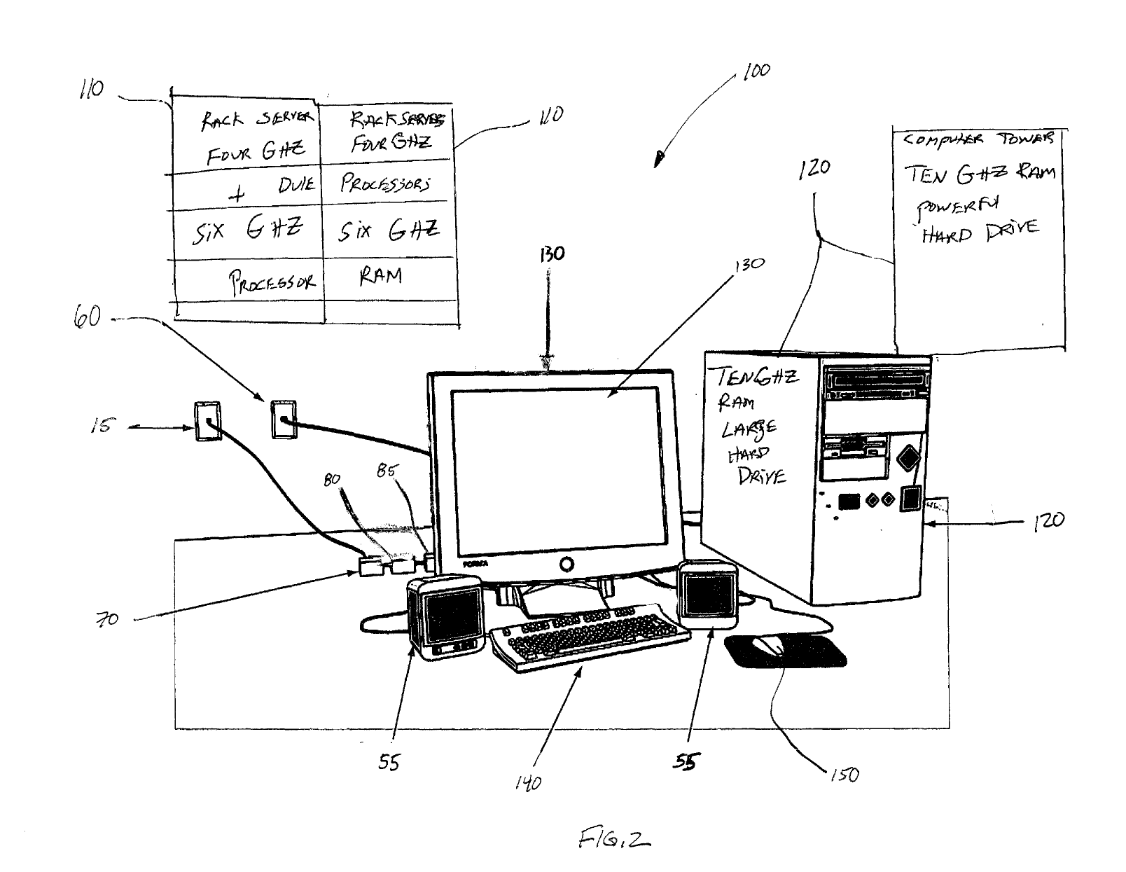

Referring now to FIG. 2 a second illustrative embodiment of a computer system 100 is shown. The system 100 includes at least one central server 110, and preferably two servers 110. Each server 110 may be a rack server that is maintained in a separate room that is cooled by an air-conditioning unit in order to maintain the servers 110 at a suitable temperature. In the illustrative embodiment, each server 110 includes 4 GHz of RAM as well as a 6 GHz dual processor.

Each server 110 is in communication with at least one, and preferably two, central computer units 120. Each computer unit 120 is capable of simultaneously running a plurality of applications. In the illustrative embodiment, each computer unit 120 includes 10 GHz of RAM, a CPU, such as a Pentium 6® processor, and a hard drive. Each computer unit 120 may be maintained in a separate room that is cooled by an air-conditioning unit in order to maintain the units 120 at a suitable temperature.

An instructor monitor 130 and one or more instructor input devices, such as a keyboard 140 and/or a mouse 150, are in communication with the server 120. In the illustrative embodiment, the monitor 130 is 148 inches by 128 inches. In addition, the system also includes a plurality of student monitors (not shown) and a plurality of student input devices (not shown), such as keyboards and/or mice, which are in communication with the central server 110. In the illustrative embodiment, each student monitor is a wireless 15 inch monitor, and each student keyboard and mouse are likewise wireless. Furthermore, the student keyboards and mice may be configured to access the server 110 remotely.

The system 100 is in communication with a network, such as the internet, by way of a network connection, such as by way of a telephone connection 60; other means for establishing a network connection will be apparent to those skilled in the art. In addition, the system 100 and its components are powered by electricity as is known in the art.

The system 100 also includes a multimedia input device, such as a cable box 70, for receiving and transmitting a multimedia signal, such as a cable television signal. The multimedia device is not limited solely to a cable box 70 and other suitable devices will be appreciated by those skilled in the art, including but not limited to a satellite television box, a television antennae, etc.

The cable box 70 is in communication with a USB hub 80 which, in turn, is in communication with an integration box 85. The integration box 85 is in communication with the monitor 130, and thus permits the monitor to display the multimedia data from the communicated from the cable box 70. Advantageously, the system 100 permits the monitor 130 to display a television signal from the cable box 70 as well as data communicated from the servers 110. Each student monitor may likewise be connected via an integration box to a multimedia input device by way of an integration box.

The system 100 may also include an instructor headset as well as a plurality of student headsets which are all in communication with the server 110. The instructor headset and student headsets may each include a microphone whereby the instructor may communicate with each student or the entire class via the headsets.

In the illustrative embodiment, the servers 110 and computer units 120 are configured such that they may serve an entire educational institution, such as, by way of example only, a university having fifteen different classes each comprising twenty students whereby each student is provided a student monitor, mouse and keyboard as previously discussed. Moreover, the server 110 and computer units 120 are configured such that the students are all working from the same computer 120 and thus an instructor may select at least one student's monitor and view the students display on the instructor monitor 130. Advantageously, this is a great deterrent to cheating among the students. Moreover, the system 100 is highly economical for such an institution as multiple users may work using the same computer units 120, thus each classroom and each student workstation does not require their own CPUs. Moreover, by way of example, while using the same computer units 120, one or more students may be able to simultaneously run different programs and/or perform various functions such as watch television, browse the internet, watch and/or listen to DVDs or CDs, use a word processor, e-mail, play games, browse the hard drive, use a scanner, use the telephone, etc.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method for instructing a plurality of students, the method comprising the steps of:
providing at least one central computer capable of simultaneously running a plurality of computer applications;
providing at lease one central server in communication with said central computer;
providing a plurality of student monitors and student input devices, each monitor and input device for use by a corresponding student and in communication with said central server;
providing a instructor monitor and at least one instructor input device for use by an instructor, said instructor monitor and input device in communication with said central server;
launching at least one application on said central computer;
viewing the application on at least one of said master monitor and said plurality of student monitors;
manipulating the application with at least one of said student monitors and student input devices; and
monitoring at least one of said student monitors on said instructor monitor.

2. The method of claim 1 further comprising the steps of:
providing at least one student headset in communication with said central server;
providing an instructor headset in communication with said central server, said central server operable to provide communication between said student headset and said instructor headset.

3. The method of claim 2 wherein said instructor headset includes a microphone for communicating with each of said student headsets.

4. A computer system comprising:
a computer;
a multimedia input device;
a network communication device;
an integration box in communication with said multimedia input device, said network communication device and said computer, wherein said computer is capable of processing data transmitted from said multimedia input device and said network communication device.

5. The system of claim 4 wherein said multimedia input device is a cable box.

6. The system of claim 4 wherein said multimedia input device is a satellite television box.

7. The system of claim 4 wherein said multimedia input device is a television antennae.

8. The system of claim 4 where said network communication device is a modem.

9. An educational computer system comprising:
at least one remote central computer unit capable of simultaneously running a plurality of computer applications;
at least one remote central server in communication with said central computer unit;
an instructor monitor and instructor input device in communication with said server; and
a plurality of student monitors and student input devices, each of said student monitors and student input devices in communication with said server.

10. The system of claim 10 further comprising:
at least one student headset in communication with said server; and
an instructor headset in communication with said server, said server operable to provide communication between said student headset and said instructor headset.

11. The system of claim 10 wherein each of said central servers includes 4 GHz of RAM and a 6 GHz dual processor.

12. The system of claim 11 wherein each of said central computer units includes 10 GHz of RAM.

13. The system of claim 10 wherein said instructor monitor is 148 inches by 128 inches.

14. The system of claim 10 wherein said student input device is a keyboard.

15. The system of claim 10 wherein said student input device is a mouse.

16. The system of claim 10 wherein said instructor input device is a keyboard.

17. The system of claim 10 wherein said instructor input device is a mouse.

18. The system of claim 10 further comprising a plurality of student speakers in communication with said server, wherein each of said speakers corresponds to one student monitor.

19. The system of claim 10 further comprising a instructor speaker in communication with said central server.

20. The system of claim 10 further comprising an air-conditioning unit for maintaining said computer and said server at a suitable operating temperature.
